(19) United States
(12) Patent Application Publication
(10) Pub. No.: US 2024/0154637 A1
(43) Pub. Date: May 9, 2024

(54) ONBOARD TRANSMISSION SYSTEM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Chaoran LI, Osaka-shi, Osaka (JP); Takashi MAEHATA, Osaka-shi, Osaka (JP)

(21) Appl. No.: 18/549,523

(22) PCT Filed: Mar. 10, 2022
(86) PCT No.: PCT/JP2022/010569

§ 371 Date: Sep. 7, 2023

(30) Foreign Application Priority Data
Mar. 12, 2021 (JP) 2021-039803

(51) Int. Cl. H04B 1/3822; H04B 1/405

(52) U.S. Cl. CPC H04B 1/3822; H04B 1/405

(57) ABSTRACT

An onboard transmission system includes: a vehicle interior-side communication unit configured to generate a digital signal that includes a plurality of pieces of data respectively corresponding to a plurality of different frequency bands, and transmit the generated digital signal to one transmission path, and a roof-side communication unit configured to distribute the digital signal received from the transmission path or a signal that is based on the digital signal received from the transmission path, into signals for a plurality of wireless machines respectively corresponding to the plurality of frequency bands.

### CROSS-REFERENCE TO RELATED APPLICATIONS

This application is the U.S. national stage of PCT/JP2022/010569 filed on Mar. 10, 2022, which claims priority of Japanese Patent Application No. JP 2021-039803 filed on Mar. 12, 2021, the contents of which are incorporated herein.

### TECHNICAL FIELD

The present disclosure relates to an onboard transmission system.

### BACKGROUND

JP 2009-177785A discloses a technique to be described below. That is to say, an onboard wireless communication apparatus of JP 2009-177785A includes: a plurality of antennas of different frequencies, a multiplexing circuit, a demultiplexing circuit, and a plurality of wireless machines corresponding to the plurality of antennas of different frequencies, the plurality of antennas being connected to one of the multiplexing circuit and the demultiplexing circuit and being further installed on the roof of the vehicle, on the upper side of the windshield, or on the upper side of the rear glass along with the multiplexing circuit or the demultiplexing circuit connected to the antennas, the plurality of wireless machines being connected to the other of the demultiplexing circuit and the multiplexing circuit, by an antenna cable on the wireless machine side, and the multiplexing circuit and the demultiplexing circuit being connected to each other by an antenna cable on the antenna apparatus side that is routed through the inside of a pillar.

A communication unit disposed on the roof of a vehicle and a communication unit disposed in a vehicle interior, for example, in order to avoid a high-temperature environment, transmit/receive signals to each other via a transmission path routed through a pillar, for example. There is a desire for a technique that can realize an excellent function related to transmission of signals between the communication unit on the roof side and the communication unit on the vehicle interior-side, in a vehicle environment in which the number of communication services to be provided tends to increase. The present disclosure has been made in order to overcome the aforementioned challenge, and an object thereof is to provide an onboard transmission system that can realize an excellent function related to transmission of signals between a communication unit on a roof side and a communication unit on a vehicle interior-side.

### SUMMARY

An onboard transmission system according to the present disclosure includes: a vehicle interior-side communication unit configured to generate a digital signal that includes a plurality of pieces of data respectively corresponding to a plurality of different frequency bands, and transmit the generated digital signal to one transmission path, and a roof-side communication unit configured to distribute the digital signal received from the transmission path or a signal that is based on the digital signal received from the transmission path, into signals for a plurality of wireless machines respectively corresponding to the plurality of frequency bands.

An aspect of the present disclosure can be realized not only as an onboard transmission system that includes such characteristic processing units, but also as a program for causing a computer to execute steps of such characteristic processing, or as a semiconductor integrated circuit that realizes a portion or the entirety of the onboard transmission system.

### Advantageous Effects

According to the present disclosure, it is possible to realize an excellent function related to transmission of signals between a communication unit on a roof side and a communication unit on a vehicle interior-side.

### BRIEF DESCRIPTION OF DRAWINGS

FIG. 1 is a diagram showing a configuration of an onboard transmission system according to a first embodiment of the present disclosure.

FIG. 2 is a diagram showing a configuration of the onboard transmission system according to the first embodiment of the present disclosure.

FIG. 3 is a diagram showing a configuration of the onboard transmission system according to the first embodiment of the present disclosure.

FIG. 4 is a diagram showing an example of a sequence of transmission processing that is performed in the onboard transmission system according to the first embodiment of the present disclosure.

FIG. 5 is a diagram showing a configuration of an onboard transmission system according to a modified example of the first embodiment of the present disclosure.

FIG. 6 is a diagram showing a configuration of the onboard transmission system according to the modified example of the first embodiment of the present disclosure.

FIG. 7 is a diagram showing a configuration of an onboard transmission system according to a second embodiment of the present disclosure.

FIG. 8 is a diagram showing a configuration of the onboard transmission system according to the second embodiment of the present disclosure.

FIG. 9 is a diagram showing an example of a sequence of transmission processing that is performed in the onboard transmission system according to the second embodiment of the present disclosure.

FIG. 10 is a diagram showing a configuration of an onboard transmission system according to a modified example of the second embodiment of the present disclosure.

FIG. 11 is a diagram showing a configuration of the onboard transmission system according to the modified example of the second embodiment of the present disclosure.

FIG. 12 is a diagram showing a configuration of an onboard transmission system according to a third embodiment of the present disclosure.

### DETAILED DESCRIPTION OF PREFERRED EMBODIMENTS

Techniques that consider an increase in the number of communication services that are to be provided in a vehicle have been developed.

First, embodiments of the present disclosure will be listed and described.

An onboard transmission system according to an embodiment of the present disclosure includes: a vehicle interior-side communication unit configured to generate a digital signal that includes a plurality of pieces of data respectively corresponding to a plurality of different frequency bands, and transmit the generated digital signal to one transmission path, and a roof-side communication unit configured to distribute the digital signal received from the transmission path or a signal that is based on the digital signal received from the transmission path, into signals for a plurality of wireless machines respectively corresponding to the plurality of frequency bands.

As described above, due to a configuration in which the vehicle interior-side communication unit generates a digital signal that includes a plurality of pieces of data respectively corresponding to a plurality of different frequency bands, and transmits the generated digital signal to one transmission path, and the roof-side communication unit distributes the digital signal received from the transmission path or a signal that is based on the digital signal, into signals for a plurality of wireless machines respectively corresponding to a plurality of frequency bands, it is possible to achieve wiring saving of the transmission path between the roof-side communication unit and the vehicle interior-side communication unit. In addition, compared with a configuration in which an analog signal is transmitted from the vehicle interior-side communication unit to the roof-side communication unit, the roof-side communication unit can distribute a digital signal into signals for a respective frequency bands through digital signal processing and transmit the signals to the wireless machines, and thus the digital signal that is based on data received from a plurality of onboard machines can be distributed into signals for the respective frequency bands to the wireless machines, with a simple and inexpensive configuration. In addition, it is possible to suppress signal loss on the transmission path compared with a configuration in which an analog signal is transmitted from the vehicle interior-side communication unit to the roof-side communication unit, and thus the transmission quality can be improved. Therefore, it is possible to realize an excellent function related to transmission of signals between a communication unit on a roof side and a communication unit on a vehicle interior side.

The roof-side communication unit may include a distribution unit provided between the transmission path and the plurality of wireless machines, and a plurality of ports respectively connectable to the plurality of wireless machines, and the distribution unit may distribute the digital signal from the transmission path, into signals for the plurality of ports.

With such a configuration, when a wireless machine is connected to a port, it is possible to transmit, to the wireless machine, a digital signal transmitted from the vehicle interior-side communication unit or a signal that is based on the digital signal, and thus the wireless machine can be easily added to the vehicle after the vehicle is manufactured, for example.

The vehicle interior-side communication unit may transmit a 1-bit wide RF (Radio Frequency) signal in which information regarding amplitude and phase appears as sparseness and density of a bit sequence on a time axis, as the digital signal to the transmission path.

With such a configuration, the roof-side communication unit does not need to DA (Digital to Analog) convert a digital signal, and thus it is possible to simplify the configuration of the roof-side communication unit.

The vehicle interior-side communication unit may transmit the digital signal subjected to error correction encoding processing, to the transmission path, and the roof-side communication unit may perform error correction processing on the digital signal received from the transmission path.

With such a configuration, in the onboard transmission system in which the roof-side communication unit disposed on the roof and the vehicle interior-side communication unit disposed in a vehicle interior in order to avoid a high-temperature environment are connected to each other by the transmission path, it is possible to mitigate the influence (impact) from noise on the transmission path, and thus the communication quality of the onboard transmission system can be improved.

Embodiments of the present disclosure will be described below with reference to the drawings. Note that the same reference numerals are given to the same or equivalent portions in the drawings, and a description thereof is not repeated. In addition, at least some of the embodiments described below may be combined as appropriate.

### First Embodiment

### Configuration and Basic Operations

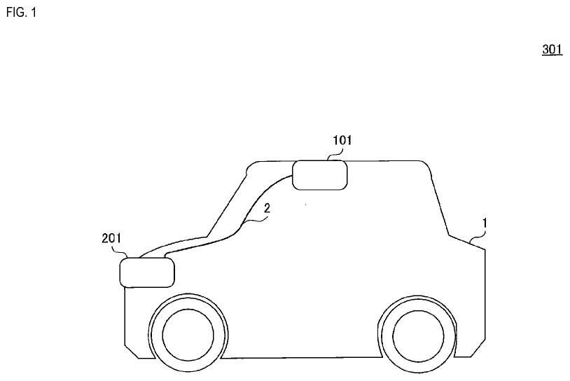

FIG. 1 is a diagram showing a configuration of an onboard transmission system according to a first embodiment of the present disclosure. As shown in FIG. 1, an onboard transmission system 301 includes a roof-side communication unit 101, a vehicle interior-side communication unit 201, and a path unit 2. The onboard transmission system 301 is mounted in a vehicle 1.

A first end and a second end of the path unit 2 are respectively connected to the roof-side communication unit 101 and the vehicle interior-side communication unit 201. The path unit 2 is installed through the inside of the front right pillar of the vehicle 1, for example. As will be described later, the path unit 2 includes one or more transmission paths.

The roof-side communication unit 101 is installed on the roof of the vehicle 1. Specifically, the roof-side communication unit 101 is installed in the space between a plate armor and an inner liner of the roof of the vehicle 1, for example. As will be described later, a plurality of wireless machines are connected to the roof-side communication unit 101. The roof-side communication unit 101 receives RF signals from a plurality of wireless machine respectively corresponding to a plurality of different frequency bands, and transmits a digital signal that is based on the received RF signals, to one transmission path in the path unit 2.

The vehicle interior-side communication unit 201 is installed in the vehicle interior of the vehicle 1. Specifically, the vehicle interior-side communication unit 201 is installed in a space in the dashboard of the vehicle 1, for example. Note that the vehicle interior-side communication unit 201 may be disposed on the floor of the vehicle 1, may be disposed on the instrument panel, or may be disposed in the trunk. The vehicle interior-side communication unit 201 processes a digital signal received from a transmission path in the path unit 2, with respect to each of the above frequency bands.

### Roof-Side Communication Unit

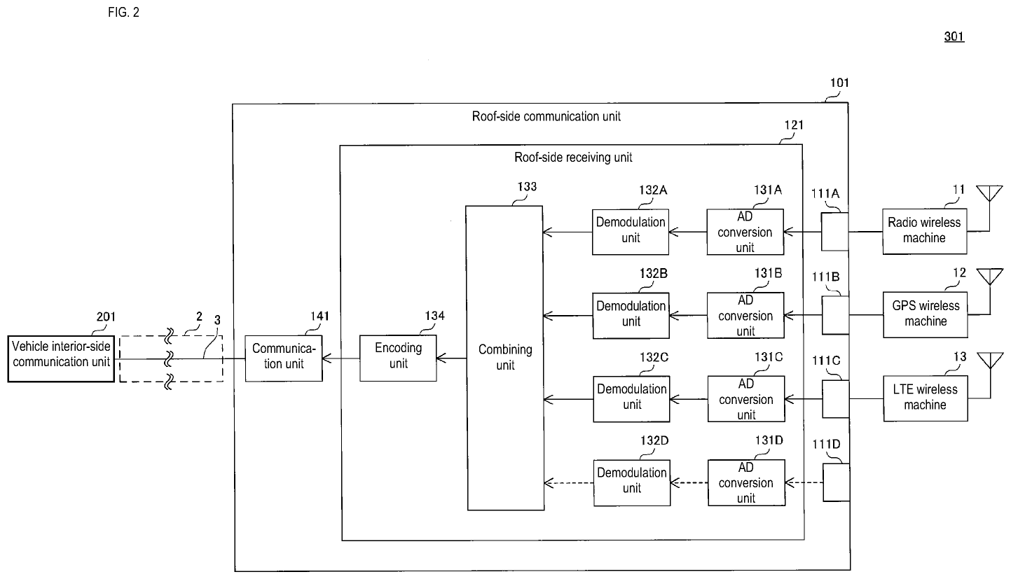

FIG. 2 is a diagram showing a configuration of the onboard transmission system according to the first embodiment of the present disclosure. FIG. 2 shows a detailed configuration of the roof-side communication unit 101. As shown in FIG. 2, the roof-side communication unit 101 includes ports 111A, 111B, 111C, and 111D, a roof-side receiving unit 121, and a communication unit 141. The roof-side receiving unit 121 includes AD (Analog to Digital) conversion units 131A, 131B, 131C, and 131D, demodulation units 132A, 132B, 132C, and 132D, a combining unit 133, and an encoding unit 134. Hereinafter, each of the ports 111A, 111B, 111C, and 111D is also referred to as a “port 111”, each of the AD conversion units 131A, 131B, 131C, and 131D is also referred to as an “AD conversion unit 131”, and each of the demodulation units 132A, 132B, 132C, and 132D is also referred to as a “demodulation unit 132”. The AD conversion unit 131 is realized by an IC (Integrated Circuit), for example. The demodulation unit 132, the combining unit 133, and the encoding unit 134 are each realized by a processor such as a CPU (Central Processing Unit) or a DSP (Digital Signal Processor). The communication unit 141 is realized by a communication IC, for example. Note that the roof-side communication unit 101 may have a configuration in which two, three, five, or more ports 111 are included, a configuration in which two, three, five, or more AD conversion units 131 are included, or a configuration in which two, three, five, or more demodulation units 132 are included.

The communication unit 141 of the roof-side communication unit 101 is connected to the path unit 2. More specifically, the path unit 2 includes a transmission path 3. The communication unit 141 is connected to the transmission path 3. The transmission path 3 is a cable that complies with the standard of Ethernet (registered trademark), USB (Universal Serial Bus), JESD, or CPRI (Common Public Radio Interface), for example.

Each port 111 is connectable to a wireless machine. Specifically, the port 111 is a connector to which a cable of the wireless machine can be attached/detached, for example. In the example shown in FIG. 2, a radio wireless machine 11 is connected to the port 111A, a GPS (Global Positioning System) wireless machine 12 is connected to the port 111B, an LTE (Long Term Evolution) wireless machine 13 is connected to the port 111C, and no wireless machine is connected to the port 111D. The user or the administrator of the vehicle 1 can add a wireless machine to the vehicle 1 by connecting the wireless machine to the port 111D after the vehicle 1 is manufactured, for example.

The radio wireless machine 11, the GPS wireless machine 12, and the LTE wireless machine 13 each include an antenna and a wireless receiving circuit (not shown). The wireless receiving circuit includes a low noise amplifier, a mixer, a low-pass filter, and the like.

The radio wireless machine 11, the GPS wireless machine 12, and the LTE wireless machine 13 respectively correspond to a plurality of different frequency bands. More specifically, the antenna of the radio wireless machine 11 is provided in correspondence with an RF signal of a frequency band allocated to FM radio, the antenna of the GPS wireless machine 12 is provided in correspondence with an RF signal of a frequency band allocated to GPS, and the antenna of the LTE wireless machine 13 is provided in correspondence with an RF signal of a frequency band allocated to LTE.

The radio wireless machine 11 receives an RF signal of the frequency band allocated to FM radio, via the antenna, generates an analog signal of an IF band that is based on the received RF signal, and transmits the analog signal to the roof-side communication unit 101. The GPS wireless machine 12 receives an RF signal of the frequency band allocated to GPS, via the antenna, generates an analog signal of an IF band that is based on the received RF signal, and transmits the analog signal to the roof-side communication unit 101. The LTE wireless machine 13 receives an RF signal of the frequency band allocated to LTE, via the antenna, generates an analog signal of an IF band that is based on the received RF signal, and transmits the analog signal to the roof-side communication unit 101.

Each AD conversion unit 131 of the roof-side receiving unit 121 converts an analog signal received from the wireless machine via the corresponding port 111, into a digital signal, and outputs the digital signal to the corresponding demodulation unit 132. More specifically, the AD conversion unit 131A converts an analog signal received from the radio wireless machine 11 via the port 111A, into a digital signal, and outputs the digital signal to the demodulation unit 132A. The AD conversion unit 131B converts an analog signal received from the GPS wireless machine 12 via the port 111B, into a digital signal, and outputs the digital signal to the demodulation unit 132B. The AD conversion unit 131C converts an analog signal received from the LTE wireless machine 13 via the port 111C, into a digital signal, and outputs the digital signal to the demodulation unit 132C.

Each demodulation unit 132 demodulates a digital signal received from the corresponding AD conversion unit 131, and outputs the demodulated digital signal to the combining unit 133. More specifically, the demodulation units 132A, 132B, and 132C subject digital signals received from the AD conversion units 131A, 131B, and 131C to orthogonal demodulation, and output the demodulated digital signals to the combining unit 133, respectively.

The combining unit 133 is provided between the transmission path 3 in the path unit 2 and the wireless machines connected to the ports 111. The combining unit 133 combines signals that are based on RF signals from the plurality of wireless machines respectively connected to the corresponding ports 111. More specifically, the combining unit 133 performs time-division multiplexing on digital signals received from the demodulation units 132A, 132B, and 132C, for example. The combining unit 133 outputs the multiplexed digital signal to the encoding unit 134.

The encoding unit 134 performs error correction encoding processing on the digital signal received from the combining unit 133. As an example, the encoding unit 134 adds parity bits to the digital signal received from the combining unit 133 as error correction encoding processing. The encoding unit 134 outputs the digital signal subjected to error correction encoding processing, to the communication unit 141.

The communication unit 141 transmits the digital signal received from the encoding unit 134, to the transmission path 3. As an example, the communication unit 141 generates an Ethernet frame in which the digital signal is stored in a payload, and transmits the generated Ethernet frame to the vehicle interior-side communication unit 201 via the transmission path 3 that is an Ethernet cable. As another example, the communication unit 141 transmits the digital signal to the vehicle interior-side communication unit 201 via the transmission path 3 that is a USB cable.

As described above, due to a configuration in which a digital signal subjected to error correction encoding processing performed by the roof-side communication unit 101 is transmitted to the vehicle interior-side communication unit 201 via the transmission path 3, it is possible to improve the communication quality in the onboard transmission system 301. In addition, with such a configuration, even when, for example, a simple cable that does not have a shielding function is used as the transmission path 3, desired communication quality can be realized, and thus it is possible to realize a reduction in the cost of the onboard transmission system 301.

It is possible to change the settings of the code rate of error correction encoding processing that is performed by the encoding unit 134, for example. The communication quality of the onboard transmission system 301 may decrease due to degradation of the transmission path 3 over time. The administrator of the onboard transmission system 301 periodically or non-periodically changes the settings of the code rate of error correction encoding processing that is performed by the encoding unit 134, in accordance with the number of years of use of the transmission path 3. Accordingly, it is possible to realize desired communication quality of the onboard transmission system 301, in a stable manner.

Note that a configuration may also be adopted in which the roof-side communication unit 101 includes wireless receiving circuits corresponding to the ports 111, instead of the wireless machines including the above-described wireless receiving circuits. In this case, a wireless receiving circuit of the roof-side communication unit 101 receives an RF signal from the wireless machine via the corresponding port 111, generates an analog signal of an IF band that is based on the received RF signal, and outputs the generated analog signal to the corresponding AD conversion unit 131.

Vehicle Interior-Side Communication Unit

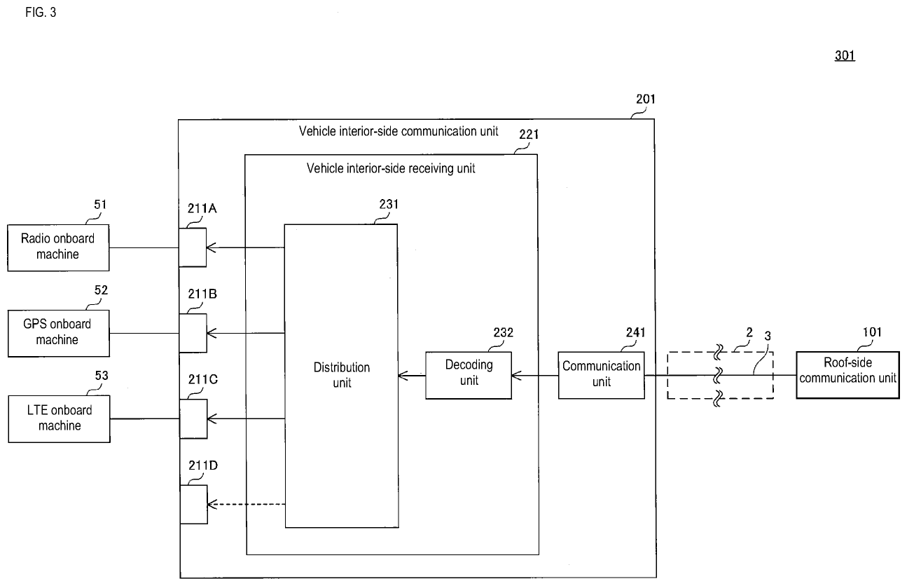

FIG. 3 is a diagram showing a configuration of the onboard transmission system according to the first embodiment of the present disclosure. FIG. 3 shows a detailed configuration of the vehicle interior-side communication unit 201. As shown in FIG. 3, the vehicle interior-side communication unit 201 includes ports 211A, 211B, 211C, and 211D, a vehicle interior-side receiving unit 221, and a communication unit 241. The vehicle interior-side receiving unit 221 includes a distribution unit 231 and a decoding unit 232. Hereinafter, each of the ports 211A, 211B, 211C, and 211D is also referred to as a “port 211”. The distribution unit 231 and the decoding unit 232 are each realized by a processor such as a CPU or a DSP. The communication unit 241 is realized by a communication IC, for example.

Each port 211 is connectable to an onboard machine. Specifically, the port 211 is a connector to which a cable of the onboard machine can be attached/detached, for example. In the example shown in FIG. 3, a radio onboard machine 51 is connected to the port 211A, a GPS onboard machine 52 is connected to the port 211B, an LTE onboard machine 53 is connected to the port 211C, and no onboard machine is connected to the port 211D. The user or the administrator of the vehicle 1 can add an onboard machine to the vehicle 1 by connecting the onboard machine to the port 211D after the vehicle 1 is manufactured, for example.

The communication unit 241 of the vehicle interior-side communication unit 201 is connected to the path unit 2. More specifically, the communication unit 241 is connected to the transmission path 3 in the path unit 2. The communication unit 241 receives, from the transmission path 3, a digital signal transmitted by the roof-side communication unit 101, and outputs the received digital signal to the decoding unit 232. As an example, the communication unit 241 receives an Ethernet frame in which the digital signal is stored, from the roof-side communication unit 101 via the transmission path 3 that is an Ethernet cable, and obtains the above digital signal from a payload of the received Ethernet frame. As another example, the communication unit 241 receives the above digital signal from the roof-side communication unit 101 via the transmission path 3 that is a USB cable. The decoding unit 232 performs error correction processing on the digital signal received from the communication unit 241. The decoding unit 232 outputs the digital signal subjected to error correction processing, to the distribution unit 231.

The distribution unit 231 separates the time division-multiplexed digital signal received from the decoding unit 232, with respect to each of the onboard machines, and transmits the separated digital signals to the corresponding onboard machines.

More specifically, the distribution unit 231 separates a digital signal of the frequency band allocated to FM radio, from the digital signals received from the decoding unit 232, and transmits the separated digital signal to the radio onboard machine 51 via the port 211A. In addition, the distribution unit 231 separates a digital signal of the frequency band allocated to GPS, from the digital signals received from the decoding unit 232, and transmits the separated digital signal to the GPS onboard machine 52 via the port 211B. In addition, the distribution unit 231 separates a digital signal of the frequency band allocated to LTE, from the digital signals received from the decoding unit 232, and transmits the separated digital signal to the LTE onboard machine 53 via the port 211C.

The radio onboard machine 51 performs processing for regenerating an FM radio based on the digital signal received from the vehicle interior-side communication unit 201, for example. In addition, the GPS onboard machine 52 calculates the current position of the vehicle 1 based on the digital signal received from the vehicle interior-side communication unit 201, for example, and transmits the calculated current position to a car navigation system mounted in the vehicle 1, for example. In addition, the LTE onboard machine 53 performs processing for regenerating Internet content such as a moving image based on the digital signal received from the vehicle interior-side communication unit 201, for example.

Operation Flow

Each apparatus in the onboard transmission system according to an embodiment of the present disclosure includes a computer that includes a memory, and a computation processing unit in the computer such as a CPU reads out, from the memory, a program that includes some or all of the steps of the following sequence, and executes the program. The programs of the plurality of apparatuses can be installed from outside. The programs of the apparatuses are distributed in a state of being stored in a recording medium.

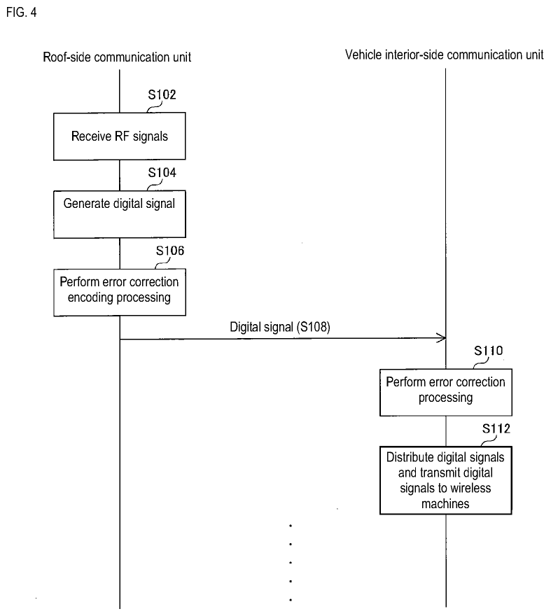

FIG. 4 is a diagram showing an example of a sequence of transmission processing that is performed in the onboard transmission system according to the first embodiment of the present disclosure.

As shown in FIG. 4, the roof-side communication unit 101 first receives RF signals from a plurality of wireless machines (step S102).

Next, the roof-side communication unit 101 generates a digital signal that are based on the received RF signals (step S104).

Next, the roof-side communication unit 101 performs error correction encoding processing on the generated digital signal (step S106).

Next, the roof-side communication unit 101 transmits the digital signal subjected to error correction encoding processing, to the vehicle interior-side communication unit 201 via the transmission path 3 (step S108).

Next, the vehicle interior-side communication unit 201 receives the digital signal from the roof-side communication unit 101 via the transmission path 3, and performs error correction processing on the received digital signal (step S110).

Next, the vehicle interior-side communication unit 201 separates the digital signal subjected to error correction processing, with respect to the onboard machines, and transmits the digital signals to the corresponding onboard machines (step S112).

### Modified Example

### Roof-Side Communication Unit

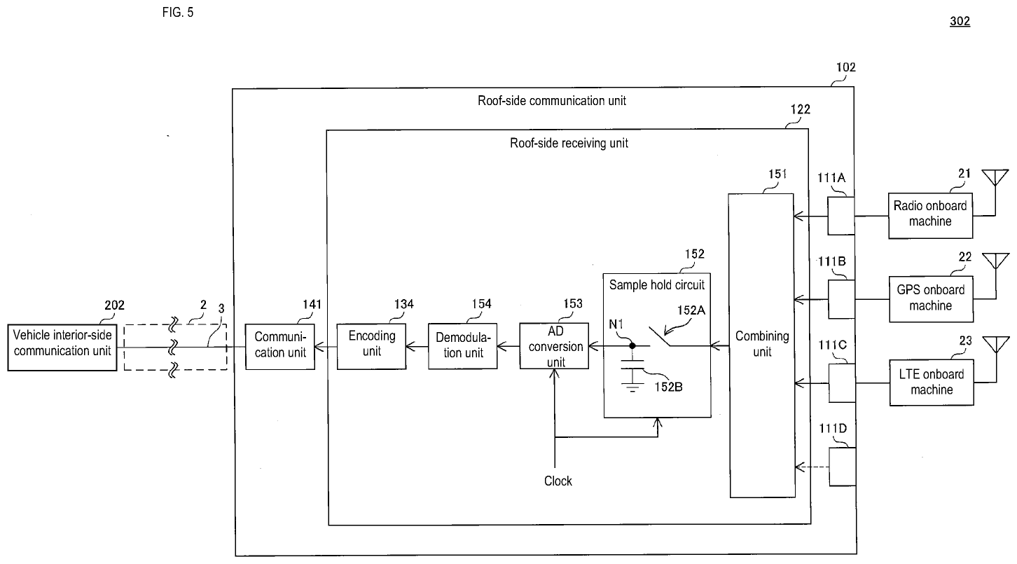

FIG. 5 is a diagram showing a configuration of an onboard transmission system according to a modified example of the first embodiment of the present disclosure. FIG. 5 shows a detailed configuration of a roof-side communication unit 102. As shown in FIG. 5, compared with the onboard transmission system 301, an onboard transmission system 302 includes the roof-side communication unit 102 in place of the roof-side communication unit 101, and includes a vehicle interior-side communication unit 202 in place of the vehicle interior-side communication unit 201.

Compared with the roof-side communication unit 101, the roof-side communication unit 102 includes a roof-side receiving unit 122 in place of the roof-side receiving unit 121. Compared with the roof-side receiving unit 121, the roof-side receiving unit 122 includes a combining unit 151, a sample hold circuit 152, an AD conversion unit 153, and a demodulation unit 154 in place of the AD conversion unit 131, the demodulation unit 132, and the combining unit 133. The sample hold circuit 152 includes a switch 152A and a capacitor 152B. The combining unit 151, the demodulation unit 154, and the encoding unit 134 are each realized by a processor such as a CPU or a DSP. The sample hold circuit 152 and the AD conversion unit 153 are each realized by an IC, for example.

A first end of the capacitor 152B of the sample hold circuit 152 is connected to a node N1 between the switch 152A and the AD conversion unit 153, and a second end of the capacitor 152B is grounded. The switch 152A of the sample hold circuit 152 and the AD conversion unit 153 operate using a common clock.

In the example shown in FIG. 5, a radio wireless machine 21 is connected to the port 111A, a GPS wireless machine 22 is connected to the port 111B, an LTE wireless machine 23 is connected to the port 111C, and no wireless machine is connected the port 111D.

The radio wireless machine 21, the GPS wireless machine 22, and the LTE wireless machine 23 each include an antenna. The radio wireless machine 21 receives an RF signal of a frequency band allocated to FM radio, via the antenna, and transmits the RF signal to the roof-side communication unit 101. The GPS wireless machine 12 receives an RF signal of a frequency band allocated to GPS, via the antenna, and transmits the RF signal to the roof-side communication unit 101. The LTE wireless machine 13 receives an RF signal of a frequency band allocated to LTE, and transmits the RF signal to the roof-side communication unit 101.

The combining unit 151 is provided between the transmission path 3 in the path unit 2 and the wireless machines respectively connected to the ports 111. The combining unit 151 combines RF signals from the plurality of wireless machines respectively connected to the corresponding ports 111. More specifically, the combining unit 151 multiplexes RF signals received from the radio wireless machine 21, the GPS wireless machine 22, and the LTE wireless machine 23 via the corresponding ports 111, and outputs the resultant to the sample hold circuit 152.

The sample hold circuit 152 receives the RF signal multiplexed by the combining unit 151. In an off-state, the switch 152A of the sample hold circuit 152 does not connect the combining unit 151 and the AD conversion unit 153 to the sample hold circuit 152, while, in an on-state, the switch 152A of the sample hold circuit 152 connects the combining unit 151 and the AD conversion unit 153 to the sample hold circuit 152. As a result of the switch 152A being switched between the on-state and the off-state according to the clock timing, an RF signal received from the combining unit 151 is converted into an analog signal of an IF band, and is output to the AD conversion unit 153. The capacitor 152B removes a high frequency component included in the analog signal output from the switch 152A.

The AD conversion unit 153 generates a digital signal by AD converting an analog signal that has passed the switch 152A of the sample hold circuit 152. More specifically, the AD conversion unit 153 converts an analog signal received from the combining unit 151 via the sample hold circuit 152, into a digital signal, and outputs the digital signal to the demodulation unit 154.

The demodulation unit 154 subjects the digital signal received from the AD conversion unit 153 to orthogonal demodulation, and outputs the demodulated digital signal to the encoding unit 134.

The encoding unit 134 performs error correction encoding processing on the digital signal received from the demodulation unit 154. The encoding unit 134 outputs the digital signal subjected to error correction encoding processing, to the communication unit 141.

The communication unit 141 transmits the digital signal received from the encoding unit 134, to the transmission path 3. As an example, the communication unit 141 transmits the digital signal to the transmission path 3 that is a USB cable.

### Vehicle Interior-Side Communication Unit

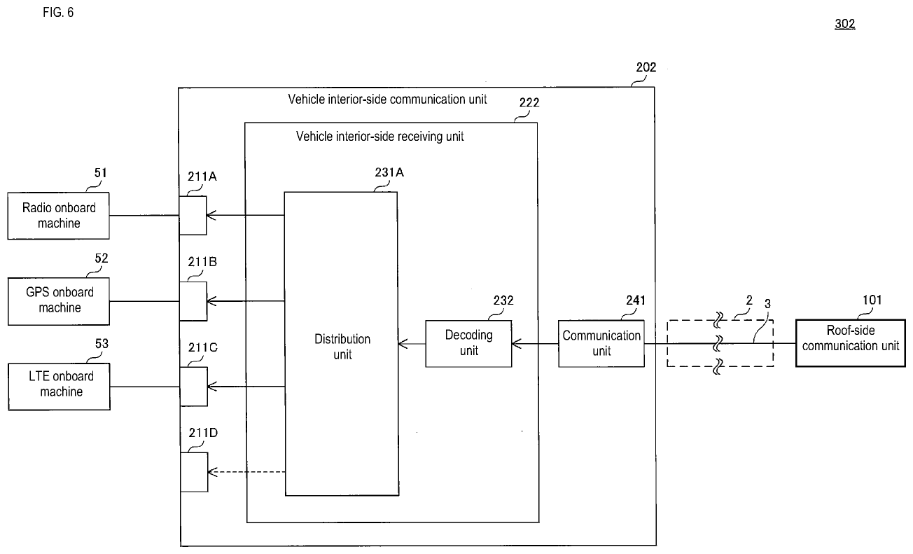

FIG. 6 is a diagram showing a configuration of the onboard transmission system according to the modified example of the first embodiment of the present disclosure. FIG. 6 shows a detailed configuration of the vehicle interior-side communication unit 202. As shown in FIG. 6, compared with the vehicle interior-side communication unit 201, the vehicle interior-side communication unit 202 includes a vehicle interior-side receiving unit 222 in place of the vehicle interior-side receiving unit 221. Compared with the vehicle interior-side receiving unit 221, the vehicle interior-side receiving unit 222 includes a distribution unit 231A in place of the distribution unit 231.

The distribution unit 231A includes a digital filter. The distribution unit 231A filters digital signals received from the decoding unit 232, and thereby distributes the digital signals with respect to the respective frequency bands, and transmits the digital signals to the corresponding onboard machines.

More specifically, the distribution unit 231A extracts a digital signal of the frequency band allocated to FM radio, from digital signals received from the decoding unit 232, and transmits the extracted digital signal to the radio onboard machine 51 via the port 211A. In addition, the distribution unit 231A extracts a digital signal of the frequency band allocated to GPS, from the digital signals received from the decoding unit 232, and transmits the extracted digital signal to the GPS onboard machine 52 via the port 211B. In addition, the distribution unit 231A extracts a digital signal of the frequency band allocated to LTE, from the digital signals received from the decoding unit 232, and transmits the extracted digital signal to the LTE onboard machine 53 via the port 211C.

Note that the onboard transmission systems 301 and 302 according to the first embodiment of the present disclosure have a configuration in which the roof-side communication units 101 and 102 include the ports 111, but there is no limitation thereto. A configuration may also be adopted in which the roof-side communication units 101 and 102 do not include the ports 111. In this case, the wireless machines are connected to the roof-side receiving units 121 and 122 in a fixed manner, for example.

In addition, the onboard transmission systems 301 and 302 according to the first embodiment of the present disclosure have a configuration in which the vehicle interior-side communication units 201 and 202 include the ports 211, but there is no limitation thereto. A configuration may also be adopted in which the vehicle interior-side communication units 201 and 202 do not include the ports 211. In this case, the onboard machines are connected to the vehicle interior-side receiving units 221 and 222 in a fixed manner, for example.

In addition, the onboard transmission systems 301 and 302 according to the first embodiment of the present disclosure have a configuration in which the roof-side receiving units 121 and 122 of the roof-side communication units 101 and 102 include the encoding unit 134, but there is no limitation thereto. A configuration may also be adopted in which the roof-side receiving units 121 and 122 do not include the encoding unit 134. In this case, the communication units 141 of the roof-side communication units 101 and 102 transmit a digital signal that has not been subjected to error correction encoding processing, to the vehicle interior-side communication units 201 and 202 via the transmission path 3.

In addition, the onboard transmission systems 301 and 302 according to the first embodiment of the present disclosure have a configuration in which, in the roof-side communication units 101 and 102, the radio wireless machines 11 and 21 are connected to the port 111A, the GPS wireless machines 12 and 22 are connected to the port 111B, and the LTE wireless machines 13 and 23 are connected to the port 111C, but there is no limitation thereto. A wireless machine other than the radio wireless machines 11 and 21, the GPS wireless machines 12 and 22, and the LTE wireless machines 13 and 23 may be connected to a port 111. In addition, a configuration may also be adopted in which the roof-side communication units 101 and 102 receive RF signals corresponding to a plurality of services or analog signals of IF bands that are based on the RF signals, from one wireless machine.

Incidentally, there is a desire for a technique that makes it possible to realize an excellent function related to transmission of signals between a communication unit on a roof side and a communication unit on a vehicle interior side. More specifically, a transmission path that connects the communication unit on the roof side and the communication unit on the vehicle interior side is routed through a pillar of the vehicle 1, for example. In a vehicle environment in which the number of communication services that are to be provided tends to increase, there is a desire for wiring saving of a transmission path in a pillar and improvement in the transmission quality between the communication unit on the roof side and the communication unit on the vehicle interior side.

In contrast, the roof-side communication units 101 and 102 of the onboard transmission systems 301 and 302 according to the first embodiment of the present disclosure receive RF signals from a plurality of wireless machines respectively corresponding to a plurality of different frequency bands, and transmit a digital signal that is based on the received RF signals, to one transmission path 3. The vehicle interior-side communication unit 201 processes the digital signal received from the transmission path 3, with respect to each of the respective frequency bands.

As described above, due to a configuration in which the roof-side communication units 101 and 102 transmit a digital signal that is based on RF signals received from a plurality of wireless machine, to the one transmission path 3, and the vehicle interior-side communication units 201 and 202 process the digital signal received from the transmission path 3, with respect to each of the respective frequency bands, it is possible to achieve wiring saving of the transmission path between the roof-side communication unit 101 and the vehicle interior-side communication unit 201 and the transmission path between the roof-side communication unit 102 and the vehicle interior-side communication unit 202. In addition, compared with a configuration in which analog signals are transmitted from the roof-side communication units 101 and 102 to the vehicle interior-side communication units 201 and 202, the vehicle interior-side communication units 201 and 202 can distribute digital signals with respect to the respective frequency bands through digital signal processing, and transmit the digital signals to onboard machines, and thus, with a simple and inexpensive configuration, it is possible to process, in accordance with respective frequency bands, a digital signal that is based on RF signals received from a plurality of wireless machines. In addition, compared with a configuration in which analog signals are transmitted from the roof-side communication units 101 and 102 to the vehicle interior-side communication units 201 and 202, it is possible to suppress signal loss on the transmission path 3, and the transmission quality can be improved.

Therefore, with the onboard transmission systems 301 and 302 according to the first embodiment of the present disclosure, it is possible to realize an excellent function related to transmission of signals between the communication unit on the roof side and the communication unit on the vehicle interior side.

Next, other embodiments of the present disclosure will be described with reference to the drawings. Note that the same reference numerals are given to the same or equivalent portions in the drawings, and a description thereof is not repeated.

### Second Embodiment

The present embodiment relates to an onboard transmission system 303 for transmitting a digital signal from a vehicle interior-side communication unit, to a roof-side communication unit, instead of transmitting the digital signal from the roof-side communication unit to the vehicle interior-side communication unit, compared with the onboard transmission system 301 according to the first embodiment. Content other than the following is similar to that of the onboard transmission system 301 according to the first embodiment.

The onboard transmission system 303 includes a vehicle interior-side communication unit 203 and a roof-side communication unit 103, which will be described later. The vehicle interior-side communication unit 203 generates a digital signal that includes a plurality of pieces of data corresponding to a plurality of respective different frequency bands, and transmits the generated digital signal to one transmission path 3. The roof-side communication unit 103 distributes the digital signal received from the transmission path 3 or a signal that is based on the digital signal received from the transmission path 3, to a plurality of wireless machines respectively corresponding to a plurality of frequency bands.

### Vehicle Interior-Side Communication Unit

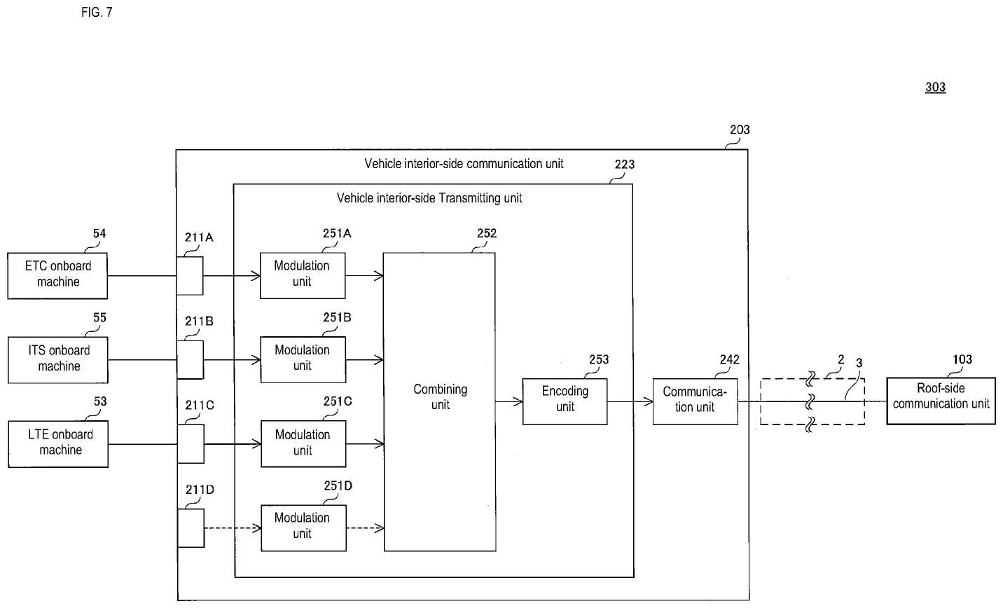

FIG. 7 is a diagram showing a configuration of the onboard transmission system according to the second embodiment of the present disclosure. FIG. 7 shows a detailed configuration of the vehicle interior-side communication unit 203. As shown in FIG. 7, the vehicle interior-side communication unit 203 includes the ports 211, a vehicle interior-side transmitting unit 223, and a communication unit 242. The vehicle interior-side transmitting unit 223 includes modulation units 251A, 251B, 251C, and 251D, a combining unit 252, and an encoding unit 253. Hereinafter, each of the modulation units 251A, 251B, 251C, and 251D is also referred to as a “modulation unit 251”. The modulation unit 251, the combining unit 252, and the encoding unit 253 are each realized by a processor such as a CPU or a DSP. The communication unit 242 is realized by a communication IC, for example.

The communication unit 242 of the vehicle interior-side communication unit 203 is connected to the path unit 2. More specifically, the communication unit 242 is connected to the transmission path 3 in the path unit 2.

In the example shown in FIG. 7, an ETC (Electronic Toll Collection System) onboard machine 54 is connected to the port 211A, an ITS (Intelligent Transport Systems) onboard machine 55 is connected to the port 211B, the LTE onboard machine 53 is connected to the port 211C, and no onboard machine is connected to the port 211D.

The ETC onboard machine 54, the ITS onboard machine 55, and the LTE onboard machine 53 generate data corresponding to different frequency bands, and transmit the generated data to the vehicle interior-side communication unit 203. More specifically, the ETC onboard machine 54 generates data that is to be included in an RF signal of a frequency band allocated to ETC and is to be wirelessly transmitted, and transmits the generated data to the vehicle interior-side communication unit 203. The ITS onboard machine 55 generates data that is to be included in an RF signal of a frequency band allocated to ITS and is to be wirelessly transmitted, and transmits the generated data to the vehicle interior-side communication unit 203. The LTE onboard machine 53 generates data that is to be included in an RF signal of a frequency band allocated to LTE and is to be wirelessly transmitted, and transmits the generated data to the vehicle interior-side communication unit 203.

Each modulation unit 251 of the vehicle interior-side transmitting unit 223 performs various types of signal processing such as orthogonal modulation on data received from an onboard machine via the corresponding port 211, and outputs a digital signal that includes the processed data, to the combining unit 252. More specifically, the modulation unit 251A outputs, to the combining unit 252, a digital signal generated by performing various types of signal processing on data received from the ETC onboard machine 54 via the port 211A. The modulation unit 251B outputs, to the combining unit 252, a digital signal generated by performing various types of signal processing on data received from the ITS onboard machine 55 via the port 211B. The modulation unit 251C outputs, to the combining unit 252, a digital signal generated by performing various types of signal processing on data received from the LTE onboard machine 53 via the port 211C.

The combining unit 252 combines digital signals that are based on data from a plurality of onboard machines respectively connected to the corresponding ports 211. More specifically, the combining unit 252 performs, for example, time-division multiplexing on the digital signals received from the modulation units 251A, 251B, and 251C. The combining unit 252 outputs the multiplexed digital signal to the encoding unit 253.

The encoding unit 253 performs error correction encoding processing on the digital signal received from the combining unit 252. The encoding unit 253 outputs the digital signal subjected to error correction encoding processing, to the communication unit 242.

The communication unit 242 transmits the digital signal received from the encoding unit 253, to the transmission path 3. As an example, the communication unit 242 generates an Ethernet frame in which the digital signal is stored in a payload, and transmits the generated Ethernet frame to the roof-side communication unit 103 via the transmission path 3 that is an Ethernet cable. As another example, the communication unit 242 transmits the digital signal to the roof-side communication unit 103 via the transmission path 3 that is a USB cable.

As described above, due to a configuration in which the vehicle interior-side communication unit 203 transmits a digital signal subjected to error correction encoding processing, to the roof-side communication unit 103 via the transmission path 3, it is possible to improve the communication quality in the onboard transmission system 303. In addition, with such a configuration, even when, for example, a simple cable that does not have a shielding function is used as the transmission path 3, desired communication quality can be realized, and thus it is possible to realize a reduction in the cost of the onboard transmission system 303.

It is possible to change the settings of the code rate of error correction encoding processing that is performed by the encoding unit 253, for example. The communication quality of the onboard transmission system 303 may decrease due to degradation of the transmission path 3 over time. The administrator of the onboard transmission system 303 periodically or non-periodically changes the settings of the code rate of error correction encoding processing that is performed by the encoding unit 253, in accordance with the number of years of use of the transmission path 3. Accordingly, it is possible to realize desired communication quality of the onboard transmission system 303, in a stable manner.

### Roof-Side Communication Unit

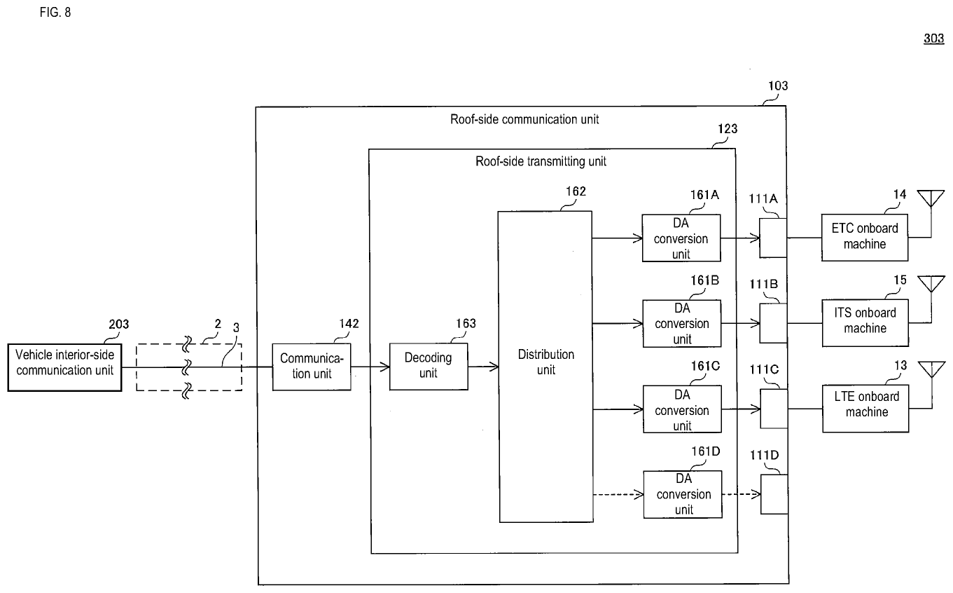

FIG. 8 is a diagram showing a configuration of the onboard transmission system according to the second embodiment of the present disclosure. FIG. 8 shows a detailed configuration of the roof-side communication unit 103. As shown in FIG. 8, the roof-side communication unit 103 includes ports 111, a roof-side transmitting unit 123, and a communication unit 142. The roof-side transmitting unit 123 includes a DA conversion units 161A, 161B, 161C, and 161D, a distribution unit 162, and a decoding unit 163. Hereinafter, each of the DA conversion units 161A, 161B, 161C, and 161D is also referred to as a “DA conversion unit 161”. The DA conversion unit 161 is realized by an IC, for example. The distribution unit 162 and the decoding unit 163 are each realized by a processor such as a CPU or a DSP. The communication unit 142 is realized by a communication IC, for example.

In the example shown in FIG. 8, an ETC wireless machine 14 is connected to the port 111A, an ITS wireless machine 15 is connected to the port 111B, the LTE wireless machine 13 is connected to the port 111C, and no wireless machine is connected to the port 111D. The ETC wireless machine 14, the ITS wireless machine 15, and the LTE wireless machine 13 each include an antenna and a wireless transmission circuit (not shown). The wireless transmission circuit includes a low noise amplifier, a mixer, and a low-pass filter.

The communication unit 142 of the roof-side communication unit 103 is connected to the path unit 2. More specifically, the communication unit 142 is connected to the transmission path 3. The communication unit 142 receives, from the transmission path 3, a digital signal transmitted by the vehicle interior-side communication unit 203, and outputs the received digital signal to the decoding unit 163. As an example, the communication unit 142 receives an Ethernet frame in which a digital signal is stored, from the vehicle interior-side communication unit 203 via the transmission path 3 that is an Ethernet cable, and obtains the digital signal from the payload of the received Ethernet frame. As another example, the communication unit 142 receives the above digital signal from the vehicle interior-side communication unit 203 via the transmission path 3 that is a USB cable.

The decoding unit 163 performs error correction processing on a digital signal received from the communication unit 142. The decoding unit 163 outputs the digital signal subjected to error correction processing, to the distribution unit 162.

The distribution unit 162 is provided between the transmission path 3 in the path unit 2 and the wireless machines connected to the ports 111. The distribution unit 162 distributes digital signals from the transmission path 3 to the plurality of ports 111. More specifically, the distribution unit 162 separates a time division-multiplexed digital signal received from the decoding unit 163, into signals for the respective wireless machines, and outputs the separated digital signals to the corresponding DA conversion units 161. Note that the distribution unit 162 may be constituted by an Ethernet switch or a USB hub.

Each DA conversion unit 161 converts a digital signal received from the distribution unit 162, into an analog signal, and transmits the analog signal to the wireless machine via the corresponding port 111. More specifically, the DA conversion unit 161A converts a digital signal received from the distribution unit 162, into an analog signal, and transmits the analog signal to the ETC wireless machine 14 via the port 111A. The DA conversion unit 161B converts a digital signal received from the distribution unit 162, into an analog signal, and transmits the analog signal to the ITS wireless machine via the port 111B. The DA conversion unit 161C converts a digital signal received from the distribution unit 162, into an analog signal, and transmits the analog signal to the LTE wireless machine 13 via the port 111C.

The ETC wireless machine 14 generates an RF signal of a frequency band allocated to ETC, from an analog signal received from the roof-side communication unit 103, using a filter, an amplifier, or the like, and transmits the generated RF signal via the antenna. The ITS wireless machine 15 generates an RF signal of a frequency band allocated to ITS, from an analog signal received from the roof-side communication unit 103, using a filter, an amplifier, or the like, and transmits the generated RF signal via the antenna. The LTE wireless machine 13 generates an RF signal of a frequency band allocated to LTE, from an analog signal received from the roof-side communication unit 103, using a filter, an amplifier, or the like, and transmits the generated RF signal via the antenna.

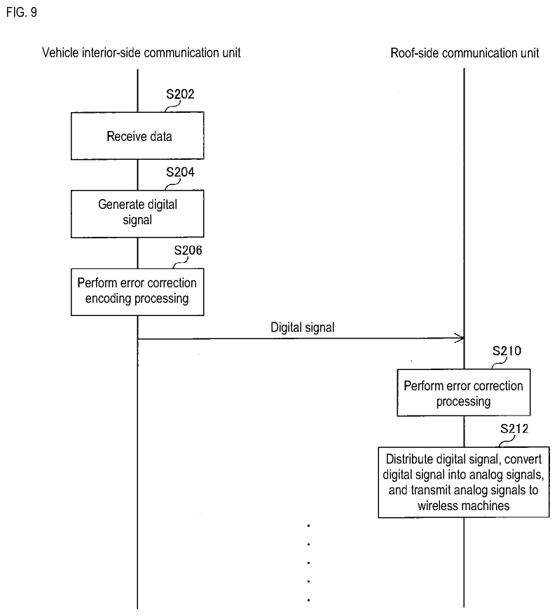

FIG. 9 is a diagram showing an example of a sequence of transmission processing that is performed in the onboard transmission system according to the second embodiment of the present disclosure.

As shown in FIG. 9, the vehicle interior-side communication unit 203 first receives data from a plurality of onboard machines (step S202).

Next, the vehicle interior-side communication unit 203 generates a digital signal that is based on pieces of the received data (step S204).

Next, the vehicle interior-side communication unit 203 performs error correction encoding processing on the generated digital signal (step S206).

Next, the vehicle interior-side communication unit 203 transmits the digital signal subjected to error correction encoding processing, to the roof-side communication unit 103 via the transmission path 3 (step S208).

Next, the roof-side communication unit 103 receives the digital signal from the vehicle interior-side communication unit 203 via the transmission path 3, and performs error correction processing on the received digital signal (step S210).

Next, the roof-side communication unit 103 distributes the digital signal subjected to error correction processing, converts the distributed digital signal into analog signals, and transmits the analog signals to a plurality of wireless machines, respectively (step S212).

### Modified Example

### Vehicle Interior-Side Communication Unit

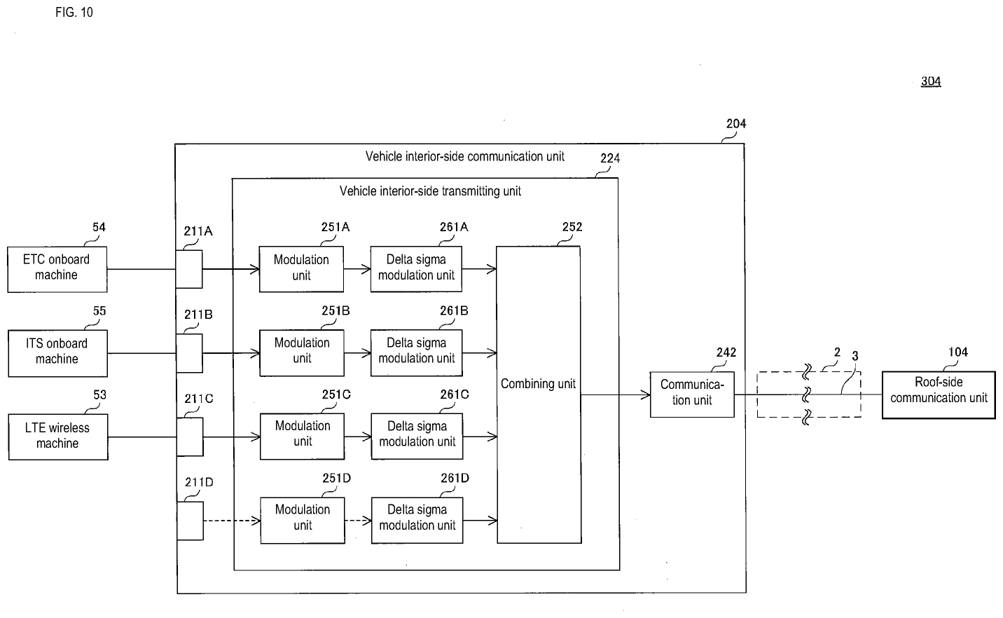

FIG. 10 is a diagram showing a configuration of an onboard transmission system according to a modified example of the second embodiment of the present disclosure. FIG. 10 shows a detailed configuration of a vehicle interior-side communication unit 204. As shown in FIG. 10, compared with the onboard transmission system 303, an onboard transmission system 304 includes the vehicle interior-side communication unit 204 in place of the vehicle interior-side communication unit 203, and includes a roof-side communication unit 104 in place of the roof-side communication unit 103.

Compared with the vehicle interior-side communication unit 203, the vehicle interior-side communication unit 204 includes a vehicle interior-side transmitting unit 224 in place of the vehicle interior-side transmitting unit 223. Compared with the vehicle interior-side transmitting unit 223, the vehicle interior-side transmitting unit 224 includes delta sigma modulation units 261A, 261B, 261C, and 261D in place of the encoding unit 253. Hereinafter, each of the delta sigma modulation units 261A, 261B, 261C, and 261D is also referred to as a “delta sigma modulation unit 261”. The modulation unit 251, the combining unit 252, and the delta sigma modulation unit 261 are each realized by a processor such as a CPU or a DSP.

The vehicle interior-side transmitting unit 224 is an example of a wireless machine of so-called software defined radio. Specifically, the vehicle interior-side transmitting unit 224 has functions similar to those of a 1-bit digital transmitter described in Takashi Maehata and three others, “SEI technical review January 2013 No. 182 Development of 1-Bit Digital Radio Frequency Transmitter”, Sumitomo Electric Industries, Ltd., January 2013, P.90-94 (Takashi Maehata and three others, “SEI technical review January 2013 No. 182 Development of 1-Bit Digital Radio Frequency Transmitter”, Sumitomo Electric Industries, Ltd., January 2013, P.90-94).

More specifically, each modulation unit 251 of the vehicle interior-side transmitting unit 224 performs various types of signal processing such as orthogonal modulation on data received from the onboard machine via the corresponding port 211, and outputs a digital signal that includes the processed data, to the corresponding delta sigma modulation unit 261. More specifically, the modulation unit 251A outputs, to the delta sigma modulation unit 261A, a digital signal generated by performing various types of signal processing on data received from the ETC onboard machine 54 via the port 211A. The modulation unit 251B outputs, to the delta sigma modulation unit 261B, a digital signal generated by performing various types of signal processing on data received from the ITS onboard machine 55 via the port 211B. The modulation unit 251C outputs, to the delta sigma modulation unit 261C, a digital signal generated by performing various types of signal processing on data received from the LTE onboard machine 53 via the port 211C.

The delta sigma modulation unit 261 generates a 1 bit wide digital signal as an RF signal by performing delta sigma modulation on a digital signal received from the corresponding modulation unit 251. This RF signal is a signal that has a spectrum at a frequency band corresponding to the onboard machine, and whose noise level at another frequency band is similar to the level of the spectrum. In this RF signal, information regarding amplitude and phase appears as sparseness and density of a bit sequence on a time axis. The delta sigma modulation unit 261 outputs the generated RF signal to the combining unit 252.

The combining unit 252 performs, for example, time-division multiplexing on RF signals received from the delta sigma modulation units 261A, 261B, and 261C. The combining unit 252 outputs the multiplexed RF signal to the communication unit 242.

The communication unit 242 transmits the RF signal received from the combining unit 252, to the transmission path 3 as a digital signal.

### Roof-Side Communication Unit

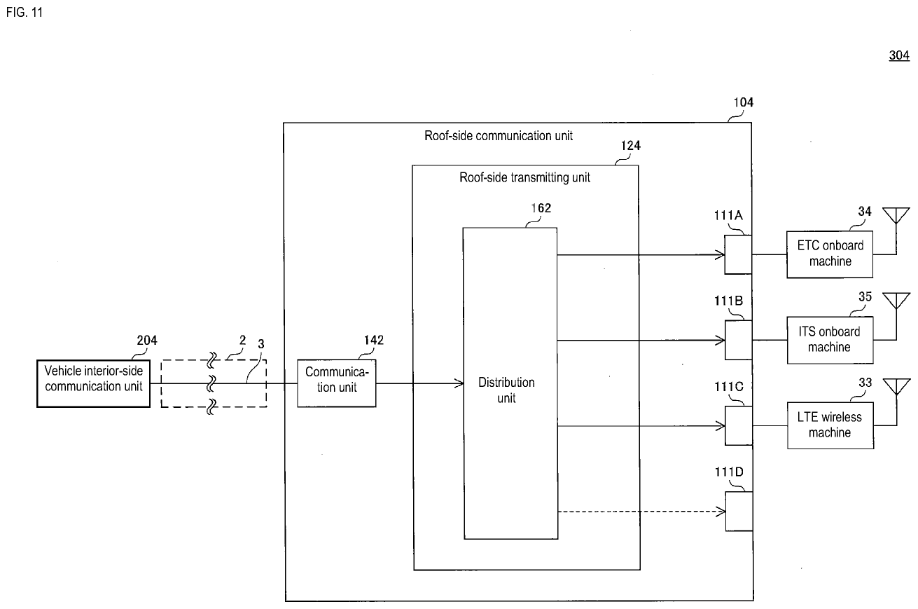

FIG. 11 is a diagram showing a configuration of the onboard transmission system according to the modified example of the second embodiment of the present disclosure. FIG. 11 shows a detailed configuration of the roof-side communication unit 104. As shown in FIG. 11, compared with the roof-side communication unit 103, the roof-side communication unit 104 includes a roof-side transmitting unit 124 in place of the roof-side transmitting unit 123. Compared with the roof-side transmitting unit 123, the roof-side transmitting unit 124 does not include the decoding unit 163 or the DA conversion unit 161.

The communication unit 142 receives an RF signal transmitted by the vehicle interior-side communication unit 204, from the transmission path 3, and outputs the received RF signal to the distribution unit 162.

The distribution unit 162 distributes a digital signal from the transmission path 3, to the plurality of ports 111. As an example, the distribution unit 162 separates a time division-multiplexed RF signal received from the communication unit 142, into signals for the respective wireless machines, and outputs the separated RF signals to the wireless machines via the corresponding ports 111.

An ETC wireless machine 34 amplifies an RF signal received from the roof-side communication unit 104, using an amplifier, for example, and transmits the RF signal via the antenna. The ITS wireless machine 15 amplifies an RF signal received from the roof-side communication unit 104, using an amplifier, for example, and transmits the RF signal via the antenna. The LTE wireless machine 13 amplifies an RF signal received from the roof-side communication unit 104, using an amplifier, for example, and transmits the RF signal via the antenna.

Note that the distribution unit 162 may be configured to branch a time division-multiplexed RF signal received from the communication unit 142, and output the resultant RF signals to the respective ports 111. In this case, each wireless machine extracts an RF signal of a frequency band allocated to the wireless machine itself, from the RF signals received from the roof-side communication unit 104, amplifies the extracted RF signal, and transmits the amplified RF signal via the antenna. Specifically, the ETC wireless machine 34 extracts an RF signal of a frequency band allocated to ETC, from the RF signals received from the roof-side communication unit 104, amplifies the extracted RF signal, and transmits the amplified RF signal via the antenna. The ITS wireless machine 15 extracts an RF signal of a frequency band allocated to ITS, from the RF signals received from the roof-side communication unit 104, amplifies the extracted RF signal, and transmits the amplified RF signal via the antenna. The LTE wireless machine 13 extracts an RF signal of a frequency band allocated to LTE, from the RF signals received from the roof-side communication unit 104, amplifies the extracted RF signal, and transmits the amplified RF signal via the antenna.

Note that the onboard transmission system 303 according to the second embodiment of the present disclosure has a configuration in which the vehicle interior-side transmitting unit 223 of the vehicle interior-side communication unit 203 includes the encoding unit 253, but there is no limitation thereto. A configuration may also be adopted in which the vehicle interior-side transmitting unit 223 does not include the encoding unit 253. In this case, the communication unit 242 of the vehicle interior-side communication unit 203 transmits digital signals that have not been subjected to error correction encoding processing, to the roof-side communication unit 103 via the transmission path 3.

In addition, the onboard transmission system 304 according to the second embodiment of the present disclosure has a configuration in which the delta sigma modulation units 261 are provided in the vehicle interior-side transmitting unit 224 of the vehicle interior-side communication unit 204, but there is no limitation thereto. The delta sigma modulation units 261 may be provided in the roof-side transmitting unit 124 of the roof-side communication unit 104 instead of being provided in the vehicle interior-side transmitting unit 224. More specifically, the communication unit 242 of the vehicle interior-side communication unit 204 receives a digital signal from the combining unit 252, and transmits the received digital signal to the roof-side communication unit 104 via the transmission path 3. The communication unit 142 of the roof-side communication unit 104 outputs, to the delta sigma modulation units 261, digital signals received via the transmission path 3. Each delta sigma modulation unit 261 generates a 1 bit wide digital signal as an RF signal, by performing delta sigma modulation on a digital signal received from the communication unit 142, and transmits the generated RF signal to the wireless machine via the corresponding port 111.

Incidentally, there is a desire for a technique that can realize an excellent function related to transmission of signals between the communication unit on the roof side and the communication unit on the vehicle interior side. More specifically, the transmission path that connects the communication unit on the roof side and the communication unit on the vehicle interior side to each other is routed through a pillar of the vehicle 1, for example. In a vehicle environment in which the number of communication services that are to be provided tends to increase, there is a desire for wiring saving of a transmission path in a pillar and improvement in the transmission quality between the communication unit on the roof side and the communication unit on the vehicle interior side.

In contrast, the vehicle interior-side communication units 202 and 203 of the onboard transmission systems 303 and 304 according to the second embodiment of the present disclosure generate a digital signal that include a plurality of pieces of data respectively corresponding to a plurality of different frequency bands, and transmit the generated digital signal to one transmission path 3. The roof-side communication units 103 and 104 distribute the digital signal received from the transmission path 3, into signals, and transmit the distributed digital signals or signals that are based on the distributed digital signals, to a plurality of wireless machines respectively corresponding to the plurality of frequency bands.

As described above, due to a configuration in which the vehicle interior-side communication units 203 and 204 generate a digital signal that includes a plurality of pieces of data respectively corresponding to a plurality of different frequency bands, and transmit the generated digital signal to one transmission path 3, and the roof-side communication units 103 and 104 distribute the digital signal received from the transmission path 3, and transmit the distributed digital signals or signals that are based on the distributed digital signals, to a plurality of wireless machines respectively corresponding to the plurality of frequency bands, it is possible to achieve wiring saving of the transmission path between the roof-side communication unit 103 and the vehicle interior-side communication unit 203 and the transmission path between the roof-side communication unit 104 and the vehicle interior-side communication unit 204. In addition, compared with a configuration in which analog signals are transmitted from the vehicle interior-side communication units 203 and 204 to the roof-side communication units 103 and 104, the roof-side communication units 103 and 104 can distribute digital signals in accordance with the respective frequency bands through digital signal processing, and transmit the digital signals to the wireless machines, and thus, with a simple and inexpensive configuration, it is possible to distribute the digital signals that are based on data received from a plurality of onboard machines, in accordance with the respective frequency bands, and to transmit the digital signals to the wireless machines. In addition, compared with a configuration in which analog signals are transmitted from the vehicle interior-side communication units 202 and 203 to the roof-side communication units 103 and 104, it is possible to suppress signal loss on the transmission path 3, and thus the transmission quality can be improved. Therefore, the onboard transmission systems 303 and 304 according to the second embodiment of the present disclosure can realize an excellent function related to transmission of signals between the communication unit on the roof side and the communication unit on the vehicle interior side.

Next, another embodiment of the present disclosure will be described with reference to the drawings. Note that the same reference numerals are given to the same or equivalent portions in the drawings, and a description thereof is not repeated.

### Third Embodiment

The present embodiment relates to an onboard transmission system 305 in which a digital signal is transmitted from a vehicle interior-side communication unit to a roof-side communication unit in addition to transmitting a digital signal from the roof-side communication unit to the vehicle interior-side communication unit, compared with the onboard transmission system 301 according to the first embodiment. Content other than the following is similar to that of the onboard transmission system 301 according to the first embodiment.

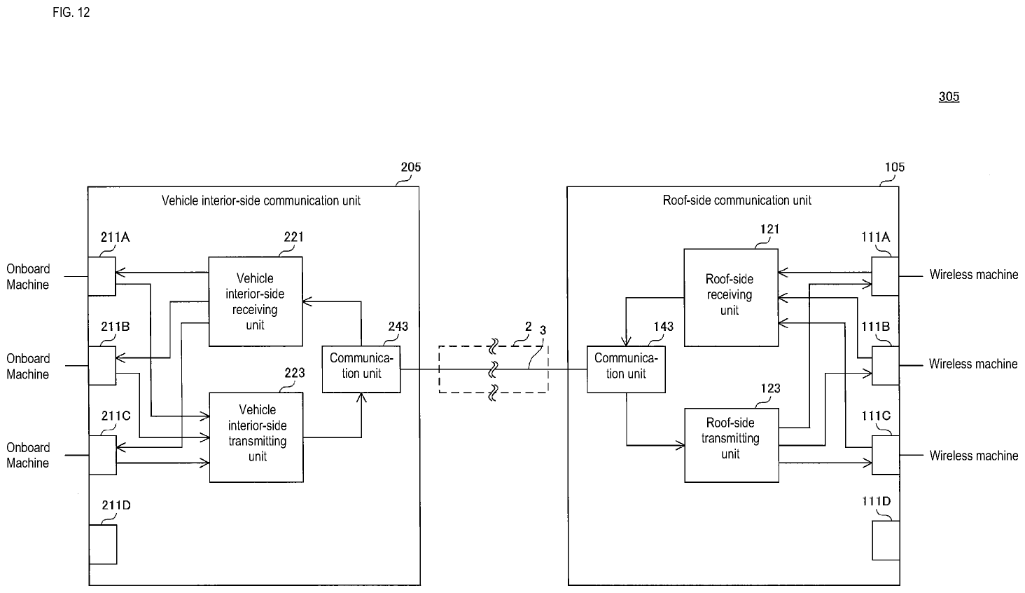

FIG. 12 is a diagram showing a configuration of the onboard transmission system according to the third embodiment of the present disclosure. As shown in FIG. 12, the onboard transmission system 305 includes a vehicle interior-side communication unit 205 and a roof-side communication unit 105.

The roof-side communication unit 105 receives RF signals from a plurality of wireless machines respectively corresponding to a plurality of different frequency bands, and transmits a digital signal that is based on the received RF signals, to one transmission path in the path unit 2. The vehicle interior-side communication unit 205 processes the digital signal received from the transmission path in the path unit 2, in accordance with the respective frequency bands.

In addition, the vehicle interior-side communication unit 205 generates a digital signal that includes a plurality of pieces of data respectively corresponding to a plurality of different frequency bands, and transmits the generated digital signal to one transmission path 3. The roof-side communication unit 105 distributes the digital signal received from the transmission path 3, and transmits the distributed digital signals or signals that are based on the distributed digital signals, to a plurality of wireless machines respectively corresponding to the plurality of frequency bands.

More specifically, the roof-side communication unit 105 includes the ports 111, the roof-side receiving unit 121, the roof-side transmitting unit 123, and a communication unit 143. The vehicle interior-side communication unit 205 includes the ports 211, the vehicle interior-side receiving unit 221, the vehicle interior-side transmitting unit 223, and a communication unit 243.

The communication unit 143 of the roof-side communication unit 105 receives, from the roof-side receiving unit 121, a digital signal that is based on RF signals from the plurality of wireless machines, and transmits the received digital signal to the transmission path 3.

The communication unit 243 of the vehicle interior-side communication unit 205 receives, from the transmission path 3, the digital signal transmitted by the roof-side communication unit 105, and outputs the received digital signal to the vehicle interior-side receiving unit 221.

The communication unit 243 of the vehicle interior-side communication unit 205 receives, from the vehicle interior-side transmitting unit 223, a digital signal that is based on data from the plurality of onboard machines, and transmits the received digital signal to the transmission path 3.

The communication unit 143 of the roof-side communication unit 105 receives, from the transmission path 3, the digital signal transmitted by the vehicle interior-side communication unit 205, and outputs the received digital signal to the roof-side transmitting unit 123.

Hereinafter, a digital signal that is being transmitted from the vehicle interior-side communication unit 205 to the roof-side communication unit 105 is also referred to as a “uplink digital signal”, and a digital signal that is being transmitted from the roof-side communication unit 105 to the vehicle interior-side communication unit 205 is also referred to as a “downlink digital signal”.

The communication unit 143 and the communication unit 243 transmit/receive digital signals via the transmission path 3 through full-duplex communication by performing time division duplex and the like, for example. Note that a configuration may also be adopted in which the communication unit 143 and the communication unit 243 transmit/receive digital signals to each other via the transmission path 3 through half-duplex communication. In addition, a configuration may also be adopted in which, when the path unit 2 includes two transmission paths 3, the communication unit 143 and the communication unit 243 transmit/receive digital signals to each other through full-duplex communication by transmitting an uplink digital signal using one of the transmission paths 3, and transmitting a downlink digital signal using the other transmission path 3.

Note that the onboard transmission system 305 according to the third embodiment of the present disclosure may have a configuration in which the roof-side communication unit 105 includes the roof-side receiving unit 122 in place of the roof-side receiving unit 121, or may have a configuration in which the roof-side communication unit 105 includes the roof-side transmitting unit 124 in place of the roof-side transmitting unit 123.

In addition, the onboard transmission system 305 according to the third embodiment of the present disclosure may have a configuration in which the vehicle interior-side communication unit 205 includes the vehicle interior-side receiving unit 222 in place of the vehicle interior-side receiving unit 221, and may have a configuration in which the vehicle interior-side communication unit 205 includes the vehicle interior-side transmitting unit 224 in place of the vehicle interior-side transmitting unit 223.

The above embodiments are examples in all respects and should not be interpreted as limiting in any manner. The scope of the present disclosure is defined not by the foregoing meanings, but is defined by the claims and intended to include all modifications within the meaning and scope equivalent to the claims.

The foregoing description includes characteristics to be added as follows: an onboard transmission system including a roof-side communication unit configured to receive RF signals from a plurality of wireless machines respectively corresponding to a plurality of different frequency bands, and transmit a digital signal that is based on the received RF signals, to one transmission path, and a vehicle interior-side communication unit configured to process the digital signal received from the transmission path with respect to each of the frequency bands. The vehicle interior-side communication unit generates a digital signal that include a plurality of pieces of data respectively corresponding to a plurality of different frequency bands, and transmits the generated digital signal to one transmission path, and the roof-side communication unit distributes the digital signal received from the transmission path or a signal that is based on the digital signal received from the transmission path, to a plurality of wireless machines respectively corresponding to the plurality of frequency bands.

1. An onboard transmission system comprising:
a vehicle interior-side communication unit configured to generate a first digital signal that includes a plurality of pieces of data respectively corresponding to a plurality of different frequency bands, and transmit the generated first digital signal to one first transmission path; and
a roof-side communication unit configured to distribute the first digital signal received from the first transmission path or a signal that is based on the first digital signal received from the first transmission path, into signals for a plurality of wireless machines respectively corresponding to the plurality of frequency bands,
wherein the roof-side communication unit receives RF signals from the plurality of wireless machines, and transmits a second digital signal that is based on the received RF signals, to one second transmission path, and
the interior-side communication unit processes the second digital signal received from the second transmission path, for each of the frequency bands.

2. The onboard transmission system according to claim 1, wherein the roof-side communication unit includes:
a distribution unit provided between the first transmission path and the plurality of wireless machines, and
a plurality of ports respectively connectable to the plurality of wireless machines,
the distribution unit distributes the first digital signal from the first transmission path, into signals for the plurality of ports,
the roof-side communication unit further includes
a combining unit provided between the second transmission path and the plurality of wireless machines, and
the combining unit combines the RF signals from the plurality of wireless machines respectively connected to the ports or signals that are based on the RF signals.

3. The onboard transmission system according to claim 1, wherein the vehicle interior-side communication unit transmits a 1-bit wide RF (Radio Frequency) signal in which information regarding amplitude and phase appears as sparseness and density of a bit sequence on a time axis, as the first digital signal to the first transmission path.

4. The onboard transmission system according to claim 1, wherein the vehicle interior-side communication unit transmits, to the first transmission path, the first digital signal subjected to error correction encoding processing,
the roof-side communication unit performs error correction processing on the first digital signal received from the first transmission path,
the roof-side communication unit transmits, to the second transmission path, the second digital signal subjected to error correction encoding processing, and
the vehicle interior-side communication unit performs error correction processing on the second digital signal received from the second transmission path.

5. The onboard transmission system according to claim 2, wherein the vehicle interior-side communication unit transmits a 1-bit wide RF (Radio Frequency) signal in which information regarding amplitude and phase appears as sparseness and density of a bit sequence on a time axis, as the first digital signal to the first transmission path.

6. The onboard transmission system according to claim 2, wherein the vehicle interior-side communication unit transmits, to the first transmission path, the first digital signal subjected to error correction encoding processing,
the roof-side communication unit performs error correction processing on the first digital signal received from the first transmission path,
the roof-side communication unit transmits, to the second transmission path, the second digital signal subjected to error correction encoding processing, and
the vehicle interior-side communication unit performs error correction processing on the second digital signal received from the second transmission path.

7. The onboard transmission system according to claim 3, wherein the vehicle interior-side communication unit transmits, to the first transmission path, the first digital signal subjected to error correction encoding processing,
the roof-side communication unit performs error correction processing on the first digital signal received from the first transmission path,
the roof-side communication unit transmits, to the second transmission path, the second digital signal subjected to error correction encoding processing, and
the vehicle interior-side communication unit performs error correction processing on the second digital signal received from the second transmission path.
